(19) United States
(12) Patent Application Publication
(10) Pub. No.: US 2022/0168841 A1
(43) Pub. Date: Jun. 2, 2022

(54) METHOD FOR FLAME CUTTING BY MEANS OF A LASER BEAM

(71) Applicant: TRUMPF WERKZEUGMASCHINEN GMBH + CO. KG, DITZINGEN (DE)

(72) Inventors: TOBIAS KAISER, RUTESHEIM (DE); CHRISTOPH KRAUS, RENNINGEN (DE)

(21) Appl. No.: 17/675,621

(22) Filed: Feb. 18, 2022

Related U.S. Application Data
(63) Continuation of application No. PCT/EP2020/069043, filed on Jul. 6, 2020.

(30) Foreign Application Priority Data
Aug. 19, 2019 (DE) 10 2019 212 360.0

(51) Int. Cl. B23K 26/04; B23K 26/38

(52) U.S. Cl. CPC B23K 26/04; B23K 26/38

(57) ABSTRACT

A method for flame cutting of a workpiece, in particular a planar workpiece, with a thickness of at least 10 mm is performed by a laser beam with power of more than 10 kW and with oxygen as a cutting gas. Accordingly, a focal position in the beam direction of the laser beam is located within the workpiece at a depth that is greater than half the thickness of the workpiece. The laser beam emerges from a nozzle opening of a cutting gas nozzle together with the cutting gas, wherein a distance of a workpiece-side nozzle end face from the workpiece surface is at least 2 mm, preferably at least 3 mm, particularly preferably at least 5 mm.

### CROSS-REFERENCE TO RELATED APPLICATION

This application is a continuation, under 35 U.S.C. § 120, of copending International Patent Application PCT/EP2020/069043, filed Jul. 6, 2020, which designated the United States; this application also claims the priority, under 35 U.S.C. § 119, of German Patent Application DE 10 2019 212 360.0, filed Aug. 19, 2019; the prior applications are herewith incorporated by reference in their entireties.

### FIELD AND BACKGROUND OF THE INVENTION

The invention relates to a method for the flame cutting of a workpiece, in particular a planar workpiece, with a thickness of at least 10 mm by means of a laser beam with a power of more than 10 kW and with oxygen as a cutting gas. In such a method for flame cutting, the laser beam is typically moved along a (generally changeable) cutting direction relative to the workpiece, with a cutting gap forming in the workpiece counter to the cutting direction.

To cut a workpiece with a comparatively large thickness, a comparatively large focal diameter of the processing laser beam is desired as a rule. The cutting gap should be so wide that liquefied workpiece material and/or slag arising during the cutting can be blown off. By contrast, a comparatively small focal diameter is desirable when processing workpieces with comparatively small thicknesses, in particular for fast laser cutting.

International patent disclosures WO 2011 124671 A1 (corresponding to U.S. Pat. Nos. 8,781,269, 9,482,821, 10,281,656 and 11,215,761) and WO 2014 060091 A1 (corresponding to U.S. Pat. No. 10,300,555) disclose switching one or more solid-state laser beams between various cores of a multi-core fiber in order to obtain a laser beam with a changeable laser beam characteristic at the fiber output, the laser beam, by means of a downstream cutting head, being able to be focused with the variable focal diameter on the workpiece to be cut. Both thick and thin workpieces are able to be cut in high quality using the described systems when cutting with a very high laser power of >10 kW, for example. However, an increase in the laser power can no longer bring about a corresponding increase in the cutting speed, that is to say the feed motion, in this power range.

International patent disclosure WO 2009 007708 A2 specifies preferred process parameters for the flame cutting of sheet metal using oxygen as a cutting gas. By way of example, the focal position of the laser beam should be arranged above the sheet-metal surface, in particular at a distance of approximately 4-5 mm from the sheet-metal surface. A distance between the sheet-metal surface and a processing nozzle is between approximately 1 mm and approximately 2 mm.

### SUMMARY OF THE INVENTION

It is an object of the present invention to specify a method for flame cutting by means of a laser beam with a laser power of more than 10 kW, within the scope of which an increase in the cutting speed can be attained.

This object is achieved by a method of the type set forth at the outset, in which a focal position in the beam direction of the laser beam is located or positioned within the workpiece at a depth that is greater than half the thickness of the workpiece, and in which the laser beam emerges from a nozzle opening of a cutting gas nozzle together with the cutting gas, wherein a distance of a workpiece-side nozzle end face from the workpiece surface is at least 2 mm, preferably at least 3 mm, particularly preferably at least 5 mm.

Expressed differently, the focal position of the laser beam has a distance of greater than half the thickness of the workpiece from the workpiece surface at which the laser beam enters the workpiece. If, as is generally conventional, the laser beam strikes the workpiece on the upper side, the focal position, that is to say the position of the beam waist of the laser beam, is situated below the workpiece center. Typically, the focal position is not located below the workpiece, that is to say the laser beam is focused on a focal position located between half the workpiece thickness and the full workpiece thickness. The greater the thickness of the workpiece, the greater the distance between the focal position and the workpiece surface.

Such a setting of the focal position deviates significantly from the previously used settings, in which the focal position is arranged at the top side of the workpiece, slightly below the top side of the workpiece or above the workpiece (cf. WO 2009 007708 A2).

As a result of the focusing according to the invention, the focal position is located very deep in the workpiece. This extremely deep focal position leads to defocusing of the laser beam at the workpiece surface and hence to a reduction in the power density at the workpiece surface. This is accompanied by a broadening of the cutting gap. Surprisingly, when increasing the laser power in the range between 10 kW and 20 kW, this can achieve a significant continuous increase in the cutting speed with, at the same time, a good cutting edge quality and good process reliability. By way of example, in the case of the previously conventional cutting parameters for the flame cutting of workpieces with a significant thickness, a 50% higher laser power led to less than a 20% feed motion increase. By contrast, using the method according to the invention, a power increase by 50% can surprisingly also bring about a feed motion increase of 50%.

The inventors have recognized that, to carry out the method, it is more advantageous if a very large distance is set between the cutting gas nozzle, more precisely the nozzle end face, and the workpiece surface since this assists the desired effect, specifically the increase in the feed motion speed with the increase in the power of the laser beam. The choice of a large distance between the cutting gas nozzle and the workpiece surface also contradicts the teaching of WO 2009 007708 A2, which specifies that a distance between the nozzle and the workpiece surface should be chosen between 1 mm and 2 mm.

In a further variant, the laser beam is generated in a laser beam generator which is connected via an optical fiber to a cutting head where the cutting gas nozzle is attached, the optical fiber being configured as a single core fiber or as a multi-core fiber. The optical fiber can be configured as described in international patent disclosure WO 2011 124671 A1, that is to say it can be configured as a multi-clad fiber with an inner fiber core and with at least one annular core. The multi-core fiber can also be configured as described in international patent disclosure WO 2014 060091 A1. When using the process parameters according to the invention, the use of a multi-core fiber is possible but no longer mandatory; rather, the optical fiber may have only a single core, as is conventional in simple or conventional optical fibers.

In a further variant, the single-core fiber has a core diameter between 50 μm and 150 μm. A core diameter of this magnitude was found to be advantageous for flame cutting. The laser beam emerging from the optical fiber is typically focused on the workpiece by a focusing device that is arranged in the cutting head and for example has the form of a focusing optical unit, for example a focusing lens.

In one variant, the laser beam has a Gaussian intensity profile at the workpiece surface. Such an intensity profile was found to be advantageous for flame cutting with the above-described parameters. The Gaussian intensity profile is typically present when the laser beam emerges from a single-core fiber, and so no additional optical elements are required to generate the Gaussian intensity profile if such an optical fiber is used.

In a further variant, the focal diameter of the laser beam at the focal position ranges between 150 μm and 300 μm, preferably is 200 μm. Such a focal diameter was found to be advantageous for the flame cutting of thick planar workpieces, in particular sheet metals, if the focal position is in the lower half of the workpiece.

In a further variant, the laser beam is generated by means of a solid-state laser or by means of a diode laser as a laser beam generator. Solid-state and diode lasers were found to be advantageous for fast cutting of thin workpieces, in particular, and have a better energy efficiency than CO2 lasers. As a result of the method according to the invention, the field of application of solid-state and diode lasers is usefully extended to flame cutting processes.

In a further variant, the overpressure (vessel pressure) of the cutting gas (oxygen) before the emergence from the nozzle opening is between 0.4 bar and 1 bar. As a result of the available higher laser power of more than 10 kW, less oxygen is required to realize a uniform exothermic combustion process. An oxygen volume that is too high would lead to an uncontrolled burnout of the cutting gap.

Other features which are considered as characteristic for the invention are set forth in the appended claims.

Although the invention is illustrated and described herein as embodied in a method for flame cutting by means of a laser beam, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, longitudinal sectional view through a cutting gas nozzle and through a planar workpiece in the case of flame cutting by means of a laser beam;

FIG. 2 is a graph showing a focal position of the laser beam as a function of a workpiece thickness; and

FIG. 3 is a perspective view of a laser cutting machine for carrying out a method for flame cutting.

### DETAILED DESCRIPTION OF THE INVENTION

In the following description of the figures, identical reference signs are used for identical or functionally identical components.

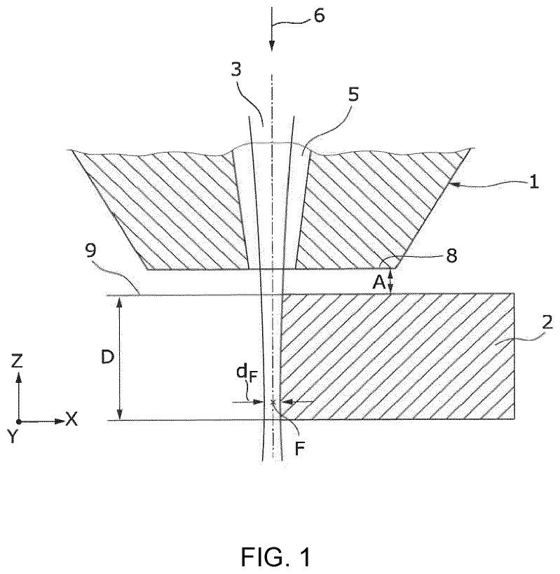

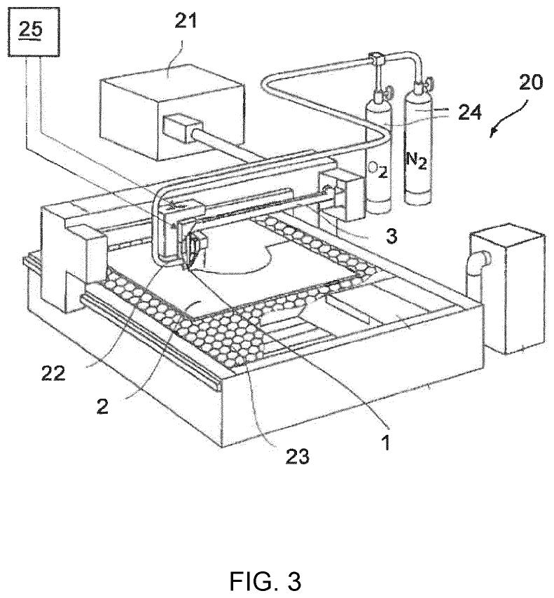

Referring now to the figures of the drawings in detail and first, particularly to FIG. 1 thereof, there is shown a cutting gas nozzle 1 for the laser cutting of a planar metallic workpiece 2 (a sheet metal) with a thickness D of at least 10 mm by means of a laser beam 3 and a cutting gas 24 (cf. FIG. 3). The cutting gas 24 and the laser beam 3 both emerge together from a nozzle opening 5 of the cutting gas nozzle 1. The laser beam 3 has a beam direction 6 which runs in the negative Z-direction of an XYZ-coordinate system. The laser cutting process is a flame cutting process, in which oxygen is used as cutting gas 24.

The cutting gas nozzle 1 is moved over the workpiece 2 in a cutting direction 7, which corresponds to the X-direction of the XYZ-coordinate system, in order to produce a cutting gap in the workpiece 2. A distance A from a workpiece-side nozzle end face 8 to the workpiece surface 9 that faces the cutting gas nozzle 1 is at least 2 mm in the example shown, preferably at least 3 mm, in particular at least 5 mm. A focal position F in a beam direction 6 of the laser beam 3 is situated within the thickness D of the workpiece 2, more precisely in the lower half of the workpiece 2 which is further away from the cutting gas nozzle 1. Expressed differently, the focal position F of the laser beam 3 in the beam direction 6 is located within the workpiece 2 at a depth that is greater than half D/2 the thickness D of the workpiece 2. In this case, a focal diameter d_{F} at the focal position F in the workpiece 2 is between 150 μm and 300 μm, preferably is approximately 200 μm.

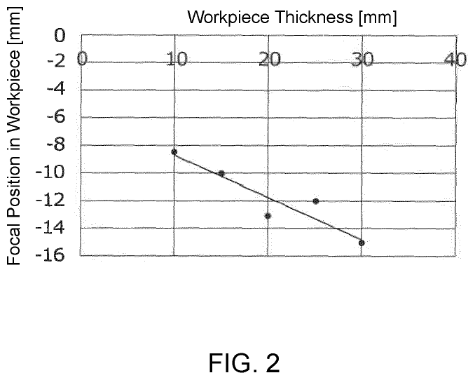

FIG. 2 shows the focal position in the workpiece 2 (sheet metal) in millimeters against the workpiece thickness (sheet-metal thickness) in millimeters in a graph. It is possible to recognize that the focal position F is ever deeper in the workpiece 2 with increasing thickness of the workpiece 2. The greater the workpiece thickness D, the greater the distance therefore is between the focal position F and the workpiece surface 9.

FIG. 3 shows a laser cutting machine 20 that is suitable for carrying out the flame cutting method described further above.

The laser cutting machine 20 contains a solid-state laser or a diode laser as a laser beam generator 21. The laser cutting machine 20 further contains a displaceable (laser) cutting head 22 and a workpiece rest 23, on which the workpiece 2 is arranged. The laser beam 3 which is guided from the laser beam generator 21 to the cutting head 22 by means of an optical fiber (not shown) is generated in the laser beam generator 21. The optical fiber is a single-core fiber in the example shown, that is to say the optical fiber has only a single core in which the laser beam 3 or the laser radiation of the laser beam generator 21 propagates. In the example shown, the single-core fiber has a core diameter which is between 50 μm and 150 μm. Alternatively, a multi-core fiber can also be used to guide the laser beam 3 from the laser beam generator 21 to the cutting head 22.

The laser beam 3 is directed at the workpiece 2 by a focusing optical unit arranged in the cutting head 22. The laser beam 3 which emerges from the single-core fiber has a Gaussian intensity profile and keeps the latter when being focused on the workpiece 2, that is to say the laser beam 3 likewise has a Gaussian intensity profile at the workpiece surface 9.

Moreover, the laser cutting machine 20 is supplied with a cutting gas 24, shown here in exemplary fashion as oxygen or nitrogen. To carry out the above-described flame cutting method, oxygen as a cutting gas 24 is supplied to the cutting gas nozzle 1 of the cutting head 22, to be precise at an overpressure of approximately 0.4-1.0 bar before the emergence of the cutting gas 24 from the cutting gas nozzle 1.

Further, the laser cutting machine 20 contains a machine controller 25 which is programmed to displace the cutting head 22 with its cutting gas nozzle 1 in accordance with a cutting contour relative to the stationary workpiece 2. The machine controller 25 also controls the power of the laser beam generator 21, which is more than 10 kW in the flame cutting process described further above and which may optionally be up to 20 kW or more. In this way it is possible to attain a cutting speed (feed motion) of 3.1 m/min in the case of a workpiece thickness of 15 mm and a cutting speed of 1.75 m/min in the case of a workpiece thickness of 25 mm, with the cutting speed increasing with increasing laser power.

The following is a summary list of reference numerals and the corresponding structure used in the above description of the invention:
1 Cutting gas nozzle
2 Workpiece
3 Laser beam
5 Nozzle opening
6 Beam direction of the laser beam
7 Cutting direction
8 Nozzle end face
9 Workpiece surface
20 Laser cutting machine
21 Laser beam generator
22 Cutting head
23 Workpiece rest
24 Cutting gas
25 Machine controller
F Focal position
D Workpiece thickness
A Distance
d_{F} Laser beam diameter

1. A method for flame cutting of a workpiece having a thickness of at least 10 mm by means of a laser beam with a power of at least 10 kW and using oxygen as a cutting gas, which comprises the steps of:
directing a focal position in a beam direction of the laser beam within the workpiece at a depth that is greater than half a thickness of the workpiece, the laser beam emerging from a nozzle opening of a cutting gas nozzle together with the cutting gas; and
setting a distance of a workpiece-side nozzle end face from a workpiece surface to be at least 2 mm.

2. The method according to claim 1, which further comprises generating the laser beam in a laser beam generator which is connected via an optical fiber to a cutting head where the cutting gas nozzle is attached, the optical fiber being configured as a single core fiber or as a multi-core fiber.

3. The method according to claim 2, which further comprises setting a core diameter of the single-core fiber to be between 50 μm and 150 μm.

4. The method according to claim 1, wherein the laser beam has a Gaussian intensity profile at the workpiece surface.

5. The method according to claim 1, which further comprises setting a focal diameter of the laser beam at the focal position to be between 150 μm and 300 μm.

6. The method according to claim 1, which further comprises generating the laser beam by means of a solid-state laser or by means of a diode laser as the laser beam generator.

7. The method according to claim 1, wherein an overpressure of the cutting gas before an emergence from the cutting gas nozzle is between 0.4 bar and 1 bar.

8. The method according to claim 1, which further comprises:
using a planar workpiece as the workpiece; and
setting the distance of the workpiece-side nozzle end face from the workpiece surface to be at least 3 mm.

9. The method according to claim 1, which further comprises setting the distance of the workpiece-side nozzle end face from the workpiece surface to be at least 5 mm.

10. The method according to claim 5, which further comprises setting the focal diameter of the laser beam at the focal position to be 200 μm.
